(19) United States
(12) Patent Application Publication
(10) Pub. No.: US 2007/0289522 A1
(43) Pub. Date: Dec. 20, 2007

(54) Improved Apparatus for Body Motion Steering Control for Water Craft

(76) Inventor: Maurice Rose'Meyer, Baysville (CA)

Correspondence Address: J. GORDON THOMSON, P.O. BOX 8865, VICTORIA, BC, V8V 3Z1, US

(21) Appl. No.: 11/424,227

(22) Filed: Jun. 14, 2006

(51) Int. Cl. G05D 1/02; B63B 17/00; B63H 25/04; B63H 25/10

(52) U.S. Cl. 114/363; 114/144 R

(57) ABSTRACT

The invention is an improved apparatus for body motion steering control for water craft powered by an outboard motor. A swivel seat is co-axially mounted to a single swivel permitting rotation of the seat about a first vertical axis. There is engagement/disengagement means mounted to the backrest of the seat. Transmission means comprises a first, second and third transmission members connected between the engagement/disengagement means and the outboard motor. The swivel seat is easily removed from the vessel by way of a pinned hinge. Safety features are incorporated which prevent over steering of the vessel when in the body motion steering mode.

### CROSS-REFERENCE TO RELATED APPLICATIONS

This non-provisional patent application is related to my issued U.S. Pat. No. 6,935,261 and uses a similar vessel, seat and outboard motor described in that patent.

### BACKGROUND OF THE INVENTION

### Field of the Invention

This invention relates to water craft. This invention further relates to an improved apparatus for body motion steering control for water craft.

Water craft with outboard motors are commonly used for recreational fishing in rivers and lakes. The outboard motors are electric or gasoline driven. One type of fishing, called trolling, requires the operation of the outboard motor while fishing. When trolling, the operator is compelled to steer the craft while fishing. Understandably, the operator, holding the fishing rod, will find it difficult to steer the craft and fish at the same time. Prior to my invention, trolling usually required setting the motor in a first desired direction along a first desired track. When the operator desires to change to a second direction and track, it is necessary to suspend fishing operations and direct full attention to the outboard motor. Clearly, this disruption of fishing operations leads to a lessened enjoyment of the sport. Furthermore, there is a physical advantage to the operator not having to twist his or her torso when turning around to operate the motor tiller to steer the vessel.

Therefore, it is desirable to have an apparatus that can be used for trolling that does not require the disruption of fishing operations to steer the craft.

### OBJECTIVES OF THE INVENTION

It is an object of the present invention to provide an improved apparatus for body motion steering control for water craft that uses fewer parts, is easier to construct and install and less expensive to purchase.

It is a further objective of the present invention to provide an improved apparatus for steering water craft that does not require the operator to suspend fishing operations in order to change the direction of the water craft and permits hands free steering of the water craft when trolling.

It is another objective of the present invention to provide an improved apparatus for steering water craft that provides for rapid disengagement of the apparatus in the event of an emergency.

It is yet another objective of the present invention to provide an improved apparatus for steering water craft that protects against undesired lockage of the apparatus.

### SUMMARY OF THE INVENTION

In order to overcome the deficiencies noted above and to meet the objectives stated herein, my invention provides for an improved apparatus for body motion steering control for water craft.

The improved apparatus is adapted for water craft having at least one flat hull cross-member having an upper surface and a base, a bow, a port side and a starboard side. The water craft is propelled by an outboard motor having a vertical drive shaft.

The apparatus comprises a seat mounted to the flat hull cross-member. The seat has a swivel mounted to its bottom and a backrest. There is engagement/disengagement means mounted one side of the backrest for easy access by an operator. The engagement/disengagement means is used for engaging and disengaging the apparatus to and from body motion steering control. There is also transmission means for transmitting body motion steering control to the outboard motor from the swivel seat.

The bottom of the swivel is mounted to a horizontal plate that is placed on the top surface of the cross-member. A vertical plate is fixed to the front of the base of the cross-member and the vertical member and horizontal member are joined by a pinned hinge. In this manner the seat can be easily attached or removed from the vessel.

When the apparatus is engaged, the swivel seat is permitted a limited amount of rotation between two stops located on the horizontal plate. This is a safety feature that prevents over-rotation of the seat and possible lock-up or reversal of control linkage.

The engagement/disengagement means comprises a mounting bracket comprising a cantilevered bottom plate and a side plate. The side plate is fixed to the side of the swivel chair. A first engagement ball is mounted to a shaft disposed in the middle of the bottom plate. When the apparatus is engaged the operator can easily disengage the apparatus by merely lifting the transmission member from the first engagement ball.

Transmission means comprises a first, second and third transmission members, a transmission bracket for joining the second member to the third member and a motor lever joining the transmission means to the outboard motor. The first transmission member is a tubular member having a first and second end. The first end mounts a ball grip and the second end is threadingly attached to the first end of the second member. The second transmission member has a single socket for engaging the first engagement ball. The second end of the second transmission member has a threaded insert for attachment to the transmission bracket. The transmission bracket also mounts one end of the control linkage secondary stop cable which is a safety feature. This end is of the cable is usually attached to the clamp by a clip ring or D-ring.

The third transmission member acts in cooperation with the outboard motor lever and prevents over-steerage when the invention is engaged. The second end of the third transmission member includes a socket adapted for engaging a second engagement ball. The opposite end of the secondary stop cable is fixed to the motor lever.

The motor lever comprises a horizontal member having a plurality of apertures that is adapted to connect the transmission members to the outboard motor. A first end of the motor lever mounts the second engagement ball and the second end of the motor lever is attached to the outboard motor transmission shaft.

When the apparatus is engaged the operator can steer the vessel by body motion commands by swiveling the seat. The swiveling motion is translated to linear motion by the transmission and back to rotational motion by the motor lever means.

When engaged, the socket in the second transmission member engages the first engagement ball. The engagement is maintained by the biasing action of a tension chord between the second transmission member and the seat.

To disengage the device, the operator lifts the first end of the first transmission member so that the first engagement ball is disengaged from the socket. The operator can now steer the craft manually by pushing or pulling on the transmission member.

### DESCRIPTION OF THE DRAWINGS

FIG. 1 is a plan view of a water craft using a preferred embodiment of my invention.

FIG. 2 is an elevation of the same water craft in FIG. 1.

FIG. 3 is a perspective view of the same water craft in FIG. 1.

FIG. 4 is a bow view of a preferred embodiment of my invention installed in a water craft.

FIG. 5 is a side view of a seat with backrest showing the location of elements of the preferred embodiment of my invention.

FIG. 6 is a view of the engagement/disengagement means of a preferred embodiment of my invention.

FIG. 7 is a view of the swivel means of a preferred embodiment of my invention.

FIG. 8 is a plan view of first and second mounting means of a preferred embodiment of my invention.

FIG. 9 is a view of the transmission means a preferred embodiment of my invention.

FIG. 10 is a schematic of the transmission means connected to the motor lever.

FIG. 11 is a schematic of the third transmission member connected to the transmission bracket and the secondary stop cable.

FIG. 12 is an illustration of the motor lever of a preferred embodiment of my invention.

FIG. 13 is an illustration of the socket locking means of a preferred embodiment of the invention.

### DETAILED DESCRIPTION OF THE PREFERRED EMBODIMENT

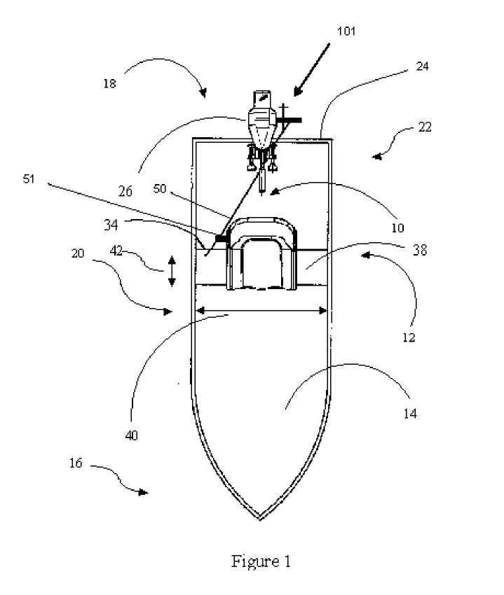

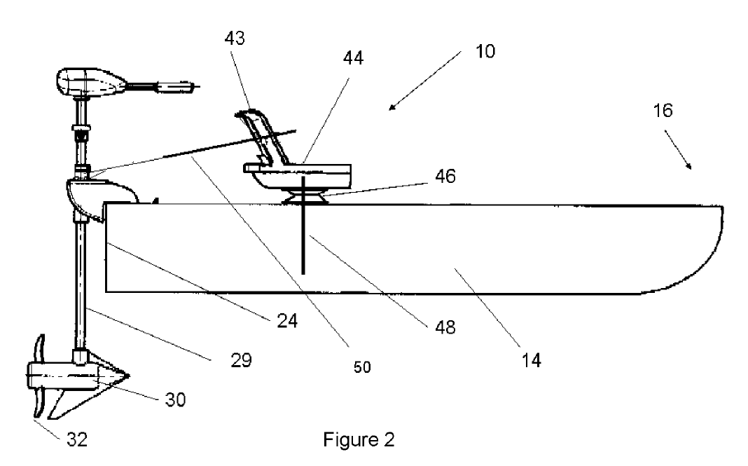

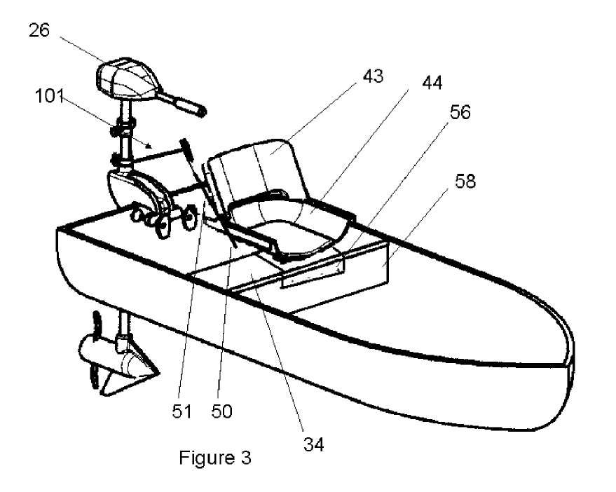

Referring to FIGS. 1 to 4, my invention (10) is an improved and simplified apparatus for body motion steering control. My invention (10) is adapted for installation in a small water craft (12) having a hull (14), a bow (16), a stern (18), a port side (20) and a starboard side (22). The stern includes a transom member (24) adapted to mount an outboard motor (26). The outboard motor can be an electric trolling motor or a small gasoline driven motor. The motor has a vertical shaft casing (29) in which the drive shaft of the motor is contained. The drive shaft is connected by a transmission (30) to a propeller (32). The small craft includes at least one flat hull cross-member (34) acting as a seat. As shown in FIG. 3, the seat (34) may have a base (58). The at least one flat hull cross-member (34) has an upper surface (38), a first length (40) and a first width (42).

My invention (10) is adapted to mate with a seat body (44) having a rigid back (43) and includes swivel means (46) permitting rotation of the seat body (44) about a first vertical axis (48). The invention (10) is mounted by mounting means (56) to a stationery base platform which is typically the flat hull cross-member (34). Mounting means is further described in detail and illustrated below. The seat body (44) is adapted to receive body motion commands from a person. These body motion commands are then transmitted by transmission means (50) to the motor (26) and turn the motor in a desired direction thereby controlling the direction of the vessel. Body motion transmission means (50) includes engagement/disengagement means (51) mounted to the port or starboard side of seat back (43). The engagement/disengagement means is adapted to engage or disengage the serially connected transmission means (50) which acts as a pull and push rod to physically move the outboard motor through motor lever (101). When engaged the transmission means transmits body motion commands to the motor. When disengaged the person can use the transmission means to command the direction of the motor by pulling or pushing on the transmission means as required. The seat (44) is adapted to swivel on swivel means (46).

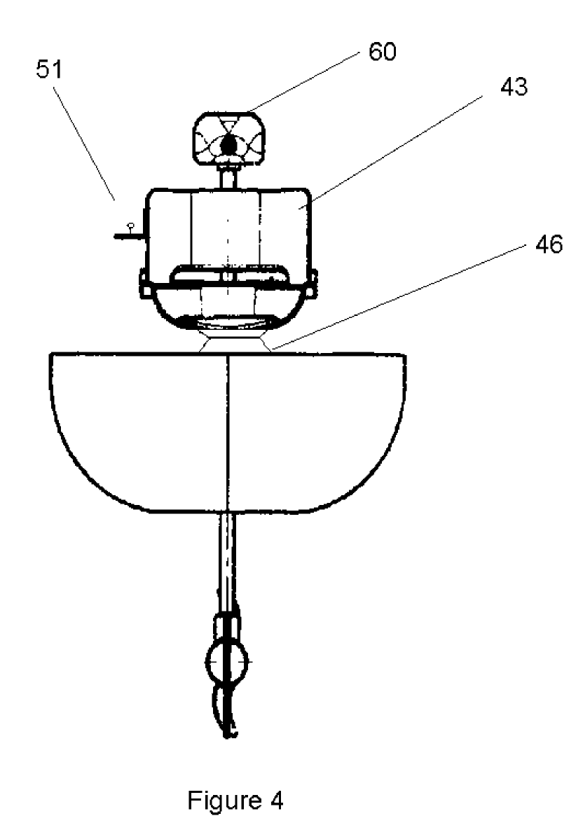

As illustrated in FIG. 4, the vessel seat may include a head rest (60) for further comfort.

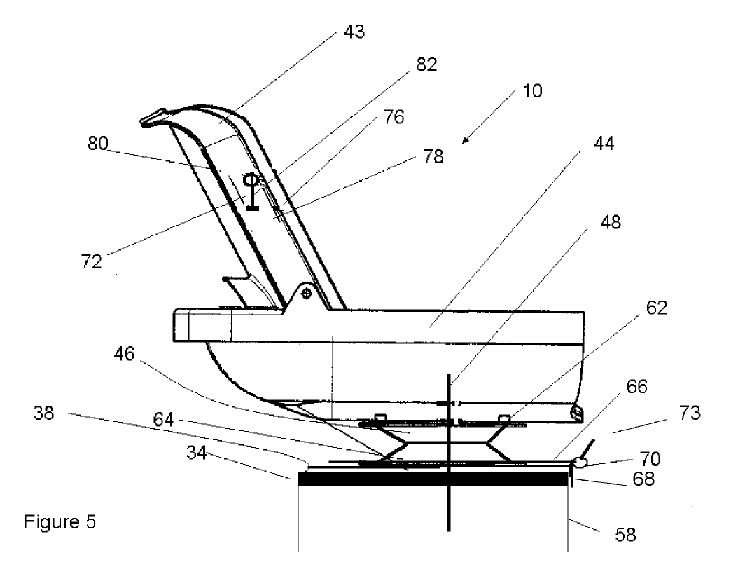

Referring now to FIG. 5, there is shown greater detail of my invention (10) as it is used to mount swivel seat (44) to the vessel cross-member (34) and base (58). My invention includes a single swivel as swivel means (46) that permits the motion of the seat body (44) around first vertical axis (48). Swivel (46) is mounted by first mounting means (62) to the bottom of the seat body (44) and second mounting means (64) to the top surface (38) of the cross-member (34). First mounting means generally comprises a mounting plate fixed to the top end of the swivel means by a suitable fastener such as screws or nut/bolt combinations. Second mounting means comprises a horizontal mounting plate (66) that is adapted sit upon the top surface of the cross-member and a vertical mounting plate (68) that is adapted to connect by connection means to the front end of the base member (58). The horizontal plate and the vertical plate are connected in a pivoting fashion by means of hinge (70). This permits quick connection of the swivel seat to cross-member (34) by inserting hinge pin (73).

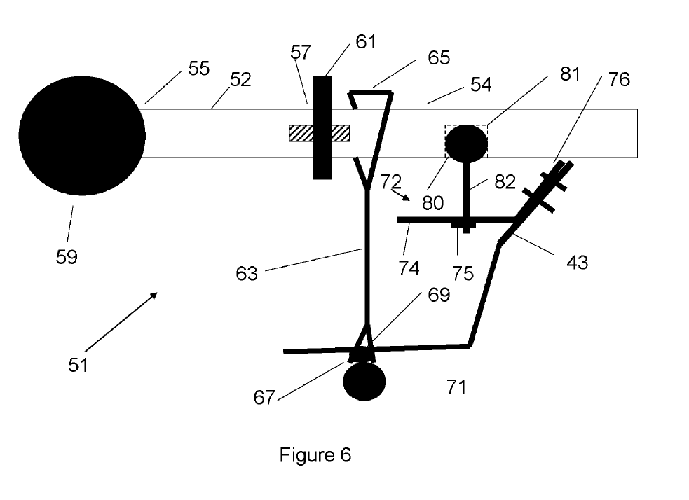

Referring to FIG. 5 and FIG. 6, there is shown engagement/disengagement means (51) comprising a mounting bracket (72) to mount the engagement/disengagement means to the side of the seat back rest (43). It is to be understood that the engagement/disengagement means can be mounted to either the port or starboard side of the seat back. The engagement/disengagement bracket further comprises a horizontally oriented cantilevered rectangular plate (74) and a plate (76) that fixes to the chair backrest (43). First engagement ball (80) is fixed to a first shaft (82) which in turn is fixed to plate (74) by fixing means such as a nut (75). As more fully explained below this arrangement maintains the second transmission member (54) engaged on the first engagement ball (80) in order to transmit body motion commands from the swivel seat to the motor.

Still referring to FIG. 6, first transmission member (52) comprises a first end (55) and a second end (57). Mounted to first transmission member first end is a ball handle (59) although any suitable handle or grip can be used. Collar (61) is mounted on the second end of the first member to prevent the tension chord (63) from moving up the first transmission member to the handle (59). First engagement ball (80) is adapted to engage a socket (81) within the second transmission member (54). The tension chord (63) has a first end (65) and a second end (67). Chord first end (63) is looped over the second transmission member and chord second end (67) is looped over a retaining lug (69). Alternatively, either or both ends of the tension chord can utilize a suitable clipping member or ring to attach to the second transmission member or the retaining lug. The second end of the chord member further includes a ball handle (71) that is used to pull the chord down to the retaining lug and place the second end of the chord (69) around the lug. The ball hand is also used to pull the chord off of the retaining lug. From FIG. 6 it is clear that the operator can lift the ball handle (59) off of the first engagement ball (80) and so disengage the invention. The transmission means can then be used by the operator steer the motor by pushing and pulling on the transmission means. The tension chord will also bias the first engagement ball within the socket (81) and retain it there securely. The first and second transmission members are threaded together at the collar (61).

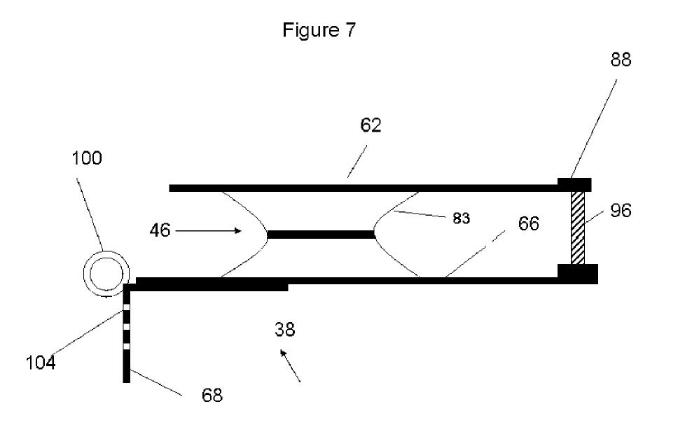

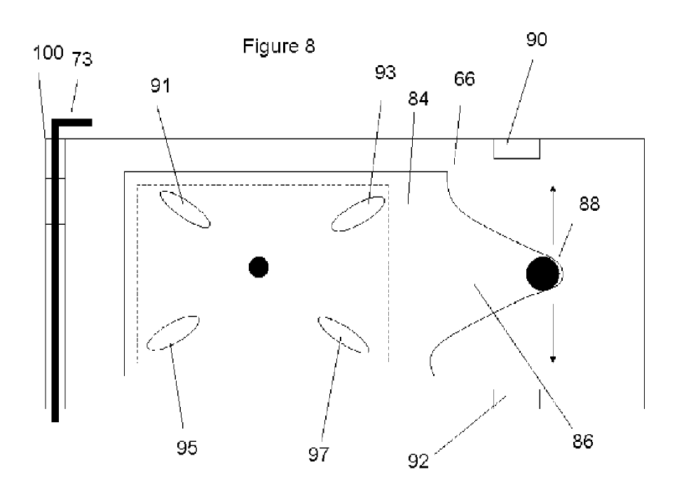

Referring now to FIG. 7 and FIG. 8, there is illustrated swivel means, first mounting means and second mounting means. Swivel means (46) is a single swivel. The top half (83) of the swivel is attached to first mounting means (62) which comprises a flat plate having a rectangular portion (84) and a generally triangular portion (86). The apex (88) of the triangular portion (86) is adapted to swing from side to side between a first stop (90) and a second stop (92) located on the second mounting means. The swinging motion is accomplished about the swivel. A stopping member (96) depends from the apex (88) and as adapted to abut against the stops preventing motion beyond those points. This arrangement permits a limited amount of swiveling action of the seat while the invention is engaged and therefore limits the amount of port and starboard motion of the vessel. This is an important safety feature of my invention as over-steering with the invention engaged may result in capsizing the vessel. Within the rectangular portion (84) of plate (62) are four apertures (91), (93), (95) and (97) that are used to fix the plate to the bottom of the seat and to the top of the top half (82) of the swivel.

Still referring to FIG. 7 and FIG. 8, there is shown second mounting means (66) comprising a rectangular plate having first (90) and second (92) stops therein and hinge-half (100) with the hinge pin (73) therein. Hinge half (100) faces the bow or is bow-ward. Plate (66) is adapted to sit upon the top surface (38) of cross-member (34) and is fixed to the vertical member (68) top-ward hinge half by pin (73). Vertical member has apertures (104) adapted for fixing to the seat base (58) by connection means such as screws or welding.

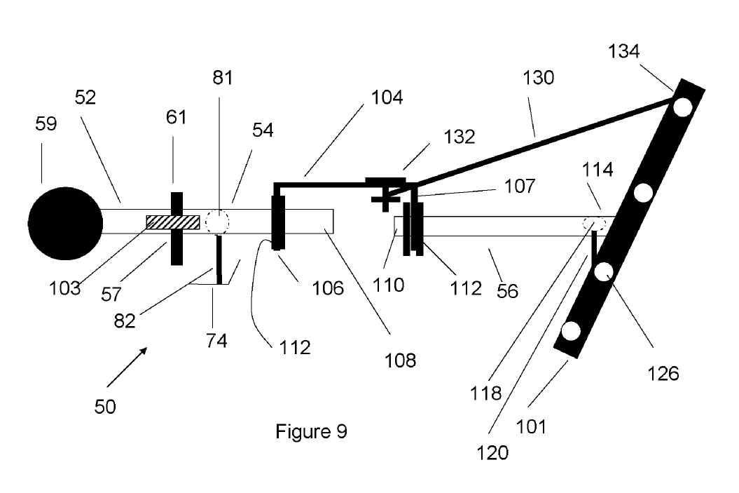

Referring now to FIG. 9 there is schematically illustrated transmission means (50) comprising a first transmission member (52), a second transmission member (54), a transmission bracket and a third transmission member (56) all connected in series to motor lever (101). Ball handle (59) is fixed to the first transmission member first end (55) and the collar (61) is fixed to the first transmission member second end (57). The first and second transmission members are joined there by a threaded connection (103). The second transmission member includes a single socket (81) which is adapted to receive in a biased relationship first engagement ball (80) mounted to shaft (82) on plate (74). Connecting the second transmission member (54) to the third transmission member (56) is transmission bracket (104). The bracket (104) has a first end (106) and a second end (107). The first end (106) of the transmission bracket (104) receives the second end (108) of the second transmission member (56) in a threaded relationship. Similarly second end (107) the transmission bracket receives the first end (110) of the third transmission member (56) in a threaded relationship. Nuts (112) on either side of the bracket secure the ends of the transmission members in place. The second end (114) of the third transmission member (56) includes a second socket (116) adapted to receive second engagement ball (118) that is attached to shaft (120) that is in turn fixed to motor lever (100). The location of the shaft can be changed by mounting it in one of a plurality of apertures (126) within the motor lever.

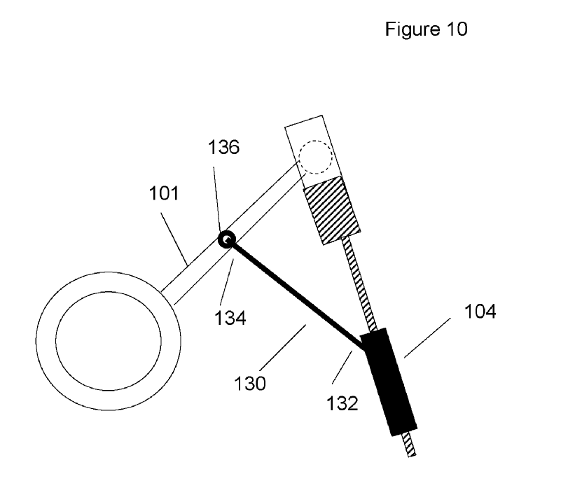

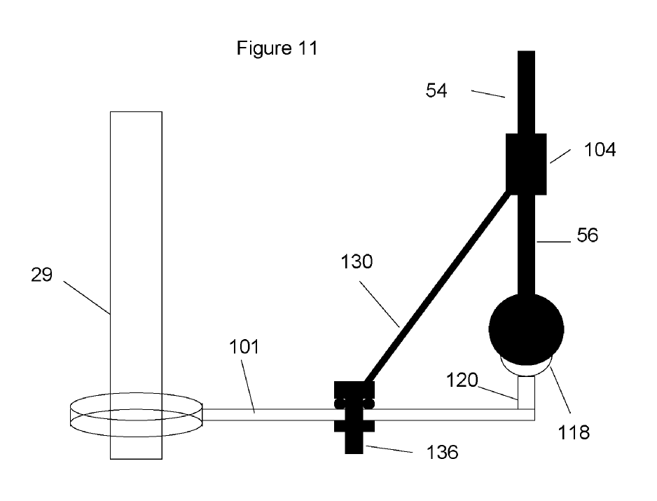

Now referring to FIGS. 9, 10 and 11 there is shown the transmission means secondary stop means comprising a flexible cable (130) having a first end (132) attached to the transmission bracket (104) and a second end (134) attached to the motor lever (101). The second end (134) of the cable (130) is fixed to the motor lever by nut and bolt means (136). The motor lever has the second engagement ball at a first end and the outboard motor transmission shaft at a second end.

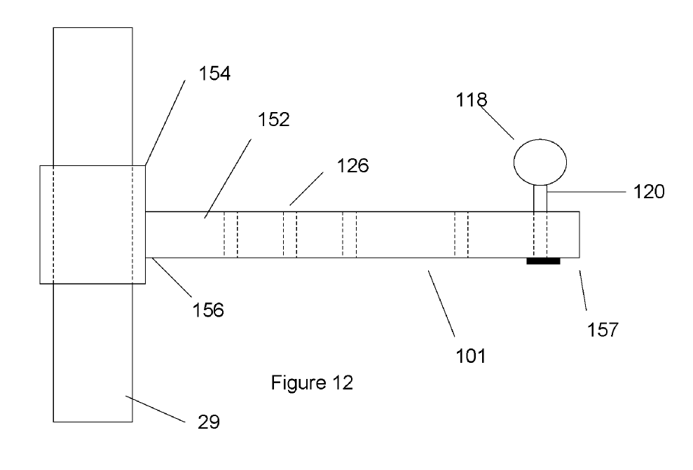

Referring to FIG. 12 there is illustrated the motor lever (101) of my invention. Motor lever (101) comprises horizontal member (152) having a collar (154) adapted to fix around the motor shaft (29) at a first end (156). At a second end (157) the member (152) has fixed to it a second engagement ball (158) mounted on shaft (160). Between the second engagement ball and the collar are disposed a plurality of apertures (126) so that the location of the second engagement ball and the location of the second end of the secondary stop cable can be adjusted along the length of the motor lever.

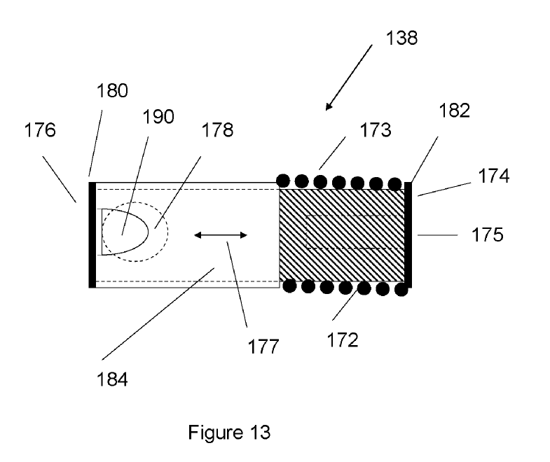

Referring now to FIG. 13 there is shown socket locking means (138) disposed on the second end of the third transmission member. The socket locking means (138) comprises a plug segment (172) having a first end (174) having a threaded bore (175) at its centre adapted for threaded engagement with the second transmission second end. The plug segment second end (176) includes an aperture (178) adapted to fully accept engulf the second engagement ball. The first and second ends of the plug segment include first and second stop rings (180) and (182). The socket locking means (138) also has a shell segment (184) that is adapted to slide between the stop rings (180) and (182). The shell segment (184) has a first operating position at the second end of the plug segment thereby exposing socket (178). The socket (178) is placed over the second engagement ball and the shell segment is slid towards the first end of the plug segment so that the aperture (190) within the shell segment engages the shaft (160) in a locking relationship. The locking arrangement is maintained by biasing spring (173) mounted between the shell and stop (182). In this manner the second end of the second transmission member is removably fixed to the motor lever.

Although this description has much specificity, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. An improved apparatus for body motion steering control for water craft, said water craft having at least one flat hull cross-member having an upper surface and a base, a bow, a port side and a starboard side, wherein the water craft is propelled by an outboard motor having a vertical drive shaft, said improved apparatus comprising:
a. a seat mounted to said at least one flat hull cross-member said seat having swivel means, a bottom surface and a backrest;
b. said swivel means having a top mounted a first mounting means and a bottom mounted to a second mounting means;
c. said backrest mounting a bracket for mounting engagement/disengagement means for engaging and disengaging the improved apparatus to and from body motion steering control; and,
d. transmission means for transmitting body motion steering control to said outboard motor.

2. The apparatus as claimed in claim 1 wherein said swivel means comprises a single swivel having a top and a bottom, and wherein said swivel is mounted between said first mounting means and said second mounting means, and further wherein first mounting means is fixed between said seat bottom and said swivel top and second mounting means is fixed to said swivel bottom.

3. The apparatus as claimed in claim 2 wherein first mounting means comprises a plate having a rectangular portion adjacent to a triangular portion having an apex and a stopping member depending from said apex, wherein said stopping member is adapted to restrict swiveling action of the seat between a first stop and a second stop.

4. The apparatus as claimed in claim 3 wherein second mounting means comprises a horizontally oriented rectangular plate adapted for placement on the cross-member upper surface, said horizontally oriented rectangular plate further comprising said first and second stops and a first half of a hinge bow-ward, and wherein second mounting means further comprises a vertically oriented rectangular plate adapted for fixing to said base of the cross-member by fixing means and a second half of a hinge top-ward so that said first half of the hinge bow-ward on the horizontally oriented rectangular plate and said second half of the hinge on the top-ward of the vertically oriented rectangular plate mesh for pinning with a pin thereby detachable fixing them together and securing the seat and swivel to the vessel.

5. The apparatus as claimed in claim 4 wherein said engagement/disengagement means comprises means for mounting the engagement/disengagement means to a side of said backrest and biasing means for biasing said engagement/disengagement means in an engagement position.

6. The apparatus as claimed in claim 5 wherein said biasing means further comprises a tension chord having a first end fixed to said transmission means and a second end fixed to the seat.

7. The apparatus as claimed in claim 6 wherein said bracket has a horizontal rectangular top surface, and wherein said horizontal rectangular surface mounts a first engagement ball mounted on a shaft fixed to the center of said top surface, and further wherein said first engagement ball is adapted to engage said transmission means in said engagement position for body motion control.

8. The apparatus as claimed in claim 7 wherein the transmission means comprises a first transmission member, a second transmission member, a third transmission member, a transmission bracket and an outboard motor lever having a first end and a second end, wherein said first transmission member, said second transmission member, said third transmission member, said transmission bracket and said outboard motor lever are serially connected thereby creating a pathway for body motion commands from the seat to the outboard motor.

9. The apparatus as claimed in claim 8 wherein said first transmission member has a first end and a second end, and wherein said first transmission member first end includes a ball handle and wherein said first transmission member second end includes a collar to prevent migration of the tension chord towards said ball handle and threaded means for connecting to said second transmission member.

10. The apparatus as claimed in claim 9 wherein the second transmission member has a first end and a second end, wherein said second transmission member first end is connected by said threaded means to the first transmission member second end, and wherein the second transmission member second end is attached to the transmission bracket first end, and further wherein the second transmission member includes a socket adapted to receive the first engagement ball thereby engaging engagement disengagement means.

11. The apparatus as claimed in claim 10 wherein the third transmission member comprises a first end and a second end, and wherein said third transmission member first end is connected to the transmission bracket second end, and wherein the third transmission member second end is pivotally connected to said outboard motor lever first end by first pivot means and said outboard motor second end is pivotally connected to the outboard motor by second pivot means.

12. The apparatus as claimed in claim 11 wherein said first pivot means comprises a second engagement ball mounted to a shaft fixed to the outboard motor lever first end and a second socket within the third transmission member second end adapted to receive said second engagement ball thereby forming a pivoting connection.

13. The apparatus as claimed in claim 12, wherein said third transmission member second end further comprises socket locking means adapted to lock the second engagement ball within said second socket.

14. The apparatus as claimed in claim 13 further comprising a secondary stop means comprising a cable having a predetermined length, a first end and a second end, wherein said cable first end is connected to the transmission bracket and the cable second end is connected to the outboard motor lever, so that as the seat swivels the cable tensions to said predetermined length thereby preventing further movement of the transmission means and acting as a secondary stop.

15. The apparatus as claimed in claim 14 wherein the socket locking means comprises a plug segment having a first end having a threaded bore centrally disposed therein and adapted for engagement with the threaded second end of the second transmission member and a second end having an socket therein, said socket adapted to accept the second engagement ball thereby connecting the first and second transmission members to the horizontal member.

16. The apparatus as claimed in claim 15 wherein said plug segment further includes a first stop ring fixed to the first end of the plug segment a second stop ring fixed to the second end of the plug segment.

17. The apparatus as claimed in claim 16 wherein the socket locking means further includes a shell segment disposed around the plug segment and adapted to slide in a biased manner by biasing means between said first stop ring and said second stop ring, wherein said shell segment comprises a socket wherein the shell segment has a first operating position wherein the plug segment socket is exposed for accepting the second engagement ball and a second operating position wherein said shell segment aperture engages said vertical shaft mounted on the second end of the horizontal member in a locking engagement thereby maintaining the second engagement ball within the second socket.
